(19) United States
(12) Patent Application Publication
(10) Pub. No.: US 2024/0109698 A1
(43) Pub. Date: Apr. 4, 2024

(54) SQUEEZE LID FOR A CONTAINER

(71) Applicant: CB Brand Strategies, LLC, Zug (CH)

(72) Inventors: Mollie Matz, Chicago, IL (US); Ericka Keeler, Chicago, IL (US); Elana Kelber Blank, Chicago, IL (US)

(73) Assignee: CB Brand Strategies, LLC, Zug (CH)

(21) Appl. No.: 18/374,222

(22) Filed: Sep. 28, 2023

Related U.S. Application Data
(60) Provisional application No. 63/411,955, filed on Sep. 30, 2022.

(51) Int. Cl. B65D 51/24; A47J 19/02; B65D 17/28

(52) U.S. Cl. CPC B65D 51/24; A47J 19/02; B65D 17/4012

(57) ABSTRACT

A container and lid having a squeeze tab and lid portions for squeezing a fruit to cause the juice to flow into an opening on the lid of the container. The lid includes a rivet at a midpoint of the lid, connecting the squeeze tab to the lid. The squeeze tab includes a tab depression on a first end of the squeeze tab proximate to a locator depression on the lid. The locator depression provides an area to place fruit to be squeezed, for example a lime wedge. A raised wall formed on the lid on one side of the locator depression assists with placement of the fruit wedge within the locator depression. The lid may form a sloped surface wherein the slope extends from a high point of a rime to a low point of the rim proximate to an opening into which juice may flow.

### FIELD OF TECHNOLOGY

The present disclosure relates generally to a beverage container.

### BACKGROUND

Carbonated beverages, including alcohol such as beer, are a popular choice for refreshments when relaxing. Consumers have developed trends of adding flavors to their beverages to enhance the flavor profile. For some, a beverage such as beer is best enjoyed with a squeeze of fruit juice from a citrus such as a lime, lemon, or orange. To add fruit juice to their beverage, a consumer may add an extract, a wedge or slice of the fruit, or simply squeeze the fruit juice into a container holding the beverage of choice. Some consumers have developed a tradition of adding the fruit wedge directly into the beverage itself.

However, the type of container used has traditionally limited the ability of a consumer to add a juice of their choice. For example, although perching a wedge of citrus on a glass is easy the same cannot be said for an aluminum can. The dimensions and shaping of cans have traditionally prevented the placement of a fruit wedge or slice on the can or provided only limited area to introduce a fruit juice into the beverage. Historically, attempting to squeeze lemon into a drink of choice has, inevitably, resulted in unwanted lemon spray as the juice is squeezed from the fruit in seemingly random directions; some of which are unintended and undesirable.

As such, the ability of a consumer to add a fruit juice to their beverage by squeezing has been limited by aim and chance. This is particularly so with cans having smaller openings for the introduction of the juice than an open glass. Similarly, the limited opening of traditional cans has prevented the addition of a fruit wedge to a beverage by not being large enough to fit the fruit wedge through.

Previous attempts to enable adding a juice to a beverage have included U.S. Pat. No. 10,815,027 to Ball Corporation (the '027 patent). The '027 patent requires modifying a pull tab to include a bowl for collecting a juice. The '027 patent's bowl includes channels at the bottom for directing the collected juice into the beverage. However, this attempt required adding complicated components to the pull tab which could be harmed during opening of the container. Additionally, the '027 merely provided a receptable on the tab of the container lid for collecting the juice. It did not provide features on the lid to contain and squeeze the fruit or limit the mess made during extraction of the juice, nor make it easier to squeeze and add a fruit wedge to the beverage.

### SUMMARY

An improvement for a container allowing for introducing/squeezing a juice into a beverage is needed. The present disclosure generally provides a container with a specially configured lid with a squeeze tab and lid portions for squeezing a fruit under the squeeze tab and causing the juice to flow into an enlarged opening on the lid of the container.

In one embodiment, a container for a beverage may include a body having a first end and a second end with a specially configured lid disposed on the first end of the body. A bottom may be disposed on the second end of the body. The lid may include a rivet at a midpoint of the lid, the rivet connecting a squeeze tab to the lid. The squeeze tab includes a tab depression on a first end of the squeeze tab proximate to a locator depression on the lid. The locator depression provides an area to place fruit to be squeezed under the tab depression of the squeeze tab, for example a fruit wedge such as lime. A raised wall may be formed on the lid on at least one side of the locator depression, to assist with placement of the fruit wedge within the locator depression. A sealing cover connected to a groove defining an edge of the sealing cover may be located proximate to the rivet. The lid may form a sloped surface wherein the slope extends from a high point of the raised wall of the rim near the locator depression to a low point of the rim proximate to an opening sealed by the sealing cover around the low point. A heightened rim may surround about two thirds of the total rim of the lid.

The container may be used in a method of adding squeezed juice to a canned beverage including retrieving a container filled with a beverage such as a carbonated beverage, locating a squeeze tab, such as a squeeze tab including a tab depression on a lid of the container, and actuating the squeeze tab to shear and displace a cover at a groove around its perimeter, thereby unsealing the container. A fruit wedge may be placed on a locator depression on the lid of the container, beneath the squeeze tab, and a force may be applied to the squeeze tab depression, pressing the squeeze tab into the fruit wedge to produce juice from the fruit wedge. The juice may flow down a slope or across the top of the lid and into an enlarged opening to flavor the beverage. The fruit wedge may be deposited into the opening, thereby adding the fruit wedge to the beverage.

Advantages of the present disclosure will become more apparent to those skilled in the art from the following description of detailed embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF THE DRAWINGS

Embodiments of devices, systems, and methods are illustrated in the figures of the accompanying drawings which are meant to be exemplary and non-limiting, in which like references are intended to refer to like or corresponding parts, and in which:

FIG. 1 illustrates a perspective view of a container with an embodiment of a squeeze lid according to the disclosure;

FIG. 2a illustrates a perspective view of an embodiment of a squeeze lid in a sealed configuration according to the disclosure;

FIG. 2b illustrates a top view of the embodiment of the lid of FIG. 2a;

FIG. 2c illustrates a bottom view of the embodiment of the lid of FIG. 2a;

FIG. 2d illustrates a first side view of the embodiment of the lid of FIG. 2a;

FIG. 2e illustrates a second side view of the embodiment of the lid of FIG. 2a;

FIG. 2f illustrates a rear view of the embodiment of the lid of FIG. 2a;

FIG. 2g illustrates a second perspective view of the embodiment of the lid of FIG. 2a;

FIG. 2h illustrates a front view of the embodiment of the lid of FIG. 2a;

FIG. 3a illustrates a perspective view of an embodiment of a squeeze lid in an opened configuration according to the disclosure;

FIG. 3b illustrates a top view of the embodiment of the lid of FIG. 3a;

FIG. 3c illustrates a bottom view of the embodiment of the lid of FIG. 3a;

FIG. 3d illustrates a first side view of the embodiment of the lid of FIG. 3a;

FIG. 3e illustrates a second side view of the embodiment of the lid of FIG. 3a;

FIG. 3f illustrates a rear view of the embodiment of the lid of FIG. 3a;

FIG. 3g illustrates a second perspective view of the embodiment of the lid of FIG. 3a;

FIG. 3h illustrates a front view of the embodiment of the lid of FIG. 3a.

FIG. 4a illustrates a perspective view of another embodiment of a container having a squeeze lid according to the disclosure;

FIG. 4b illustrates a perspective view of the embodiment of the lid of FIG. 4a;

FIG. 4c illustrates a perspective view of the embodiment of the lid of FIG. 4a

FIG. 5a illustrates a perspective view of an embodiment of a lid according to the disclosure;

FIG. 5b illustrates a perspective view of the embodiment of the lid of FIG. 5a;

FIG. 6a illustrates a perspective view of an embodiment of a container having a squeeze lid covered by a cap according to the disclosure;

FIG. 6b illustrates a perspective view of a container with the embodiment of a lid of FIG. 6a without the cap;

FIG. 7 illustrates a side view of an embodiment of a container having a squeeze lid according to the disclosure;

FIG. 8 illustrates a top view of a carrying package storing a container with a squeeze lid;

FIG. 9a illustrates a perspective view of an alternative embodiment of a container having a squeeze lid according to the disclosure;

FIG. 9b illustrates a top view of the alternative embodiment of the lid of FIG. 9a;

FIG. 9c illustrates a bottom view of the alternative embodiment of the lid of FIG. 9a;

FIG. 9d illustrates a first side view of the alternative embodiment of the lid of FIG. 9a;

FIG. 9e illustrates a second side view of the alternative embodiment of the lid of FIG. 9a;

FIG. 9f illustrates a rear view of the alternative embodiment of the lid of FIG. 9a;

FIG. 10 is a flow chart of a method for adding juice to a beverage using a squeeze lid according to the disclosure.

### DETAILED DESCRIPTION

The present disclosure generally relates to beverage containers configured to allow the introduction of a juice into a beverage such as a carbonated beverage. Additionally, the beverage container may include an opening sized to allow a fruit slice or fruit wedge to be inserted into the container for adding to the beverage (“enlarged opening”).

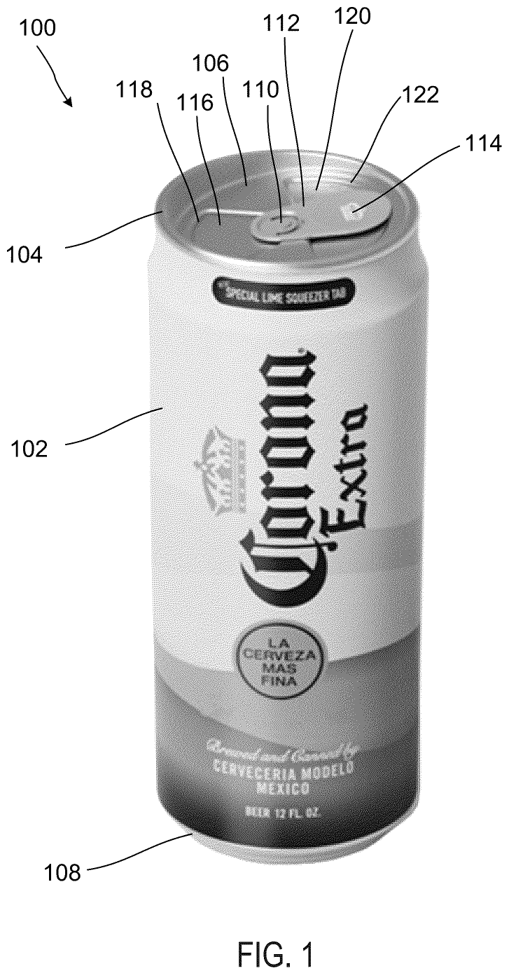

Referring to FIG. 1, a first perspective view of an embodiment of a container 100 is illustrated with a lid 106 having features that work together to extract juice from a fruit wedge. A body 102 of the container includes the lid 106 at a first end and a bottom 108 at a second end. The lid 106 includes multiple features enabling placement and squeezing of the fruit wedge, and introduction of the squeezed juice into a beverage, such as a carbonated beverage, within the container 100. A rivet 110 is located at an approximate midpoint of the lid 106. A rim 104 including a raised lip may surround the edge of the lid 106.

The rivet 110 may connect a squeeze tab 112 to the lid 106. The squeeze tab 112 may be rotated to apply a pressure to a cover 116 sealing an opening (not shown when the cover 116 is in place), when the squeeze tab 112 is lifted from a first position where the cover 116 is in place or closed to a second position where the cover is displaced as described hereinafter and the lid 106 is opened. Additionally, the squeeze tab 112 may be rotated about the rivet 110 clockwise or counter-clockwise up to approximately 180 degrees.

In operation, a force may be applied to the squeeze tab 112 to lift it from the first position to the second position which in turn acts as a lever to apply the force against the cover 116. A groove 118 around the cover 116 creates a shear point around the cover so that when the squeeze tab 112 is lifted to the second position which in turn acts as a lever to apply the force against the cover, the force separates the cover 116 from the lid 106 along at least a portion of the groove 118. At least one edge of the cover 116 shears from the groove 118 when the applied force reaches at least a predetermined amount. When the cover 116 is separated from the lid 106, it may rotate around hinge points along an edge of the cover 116 where the cover is not sheared from the lid and instead remains attached. As a result, the cover 116 enters the opening (not shown in the view of FIG. 1) and forms an aperture sufficiently sized to fit a fruit wedge and/or allows a juice to be added to a beverage within the container 100, as described hereinafter.

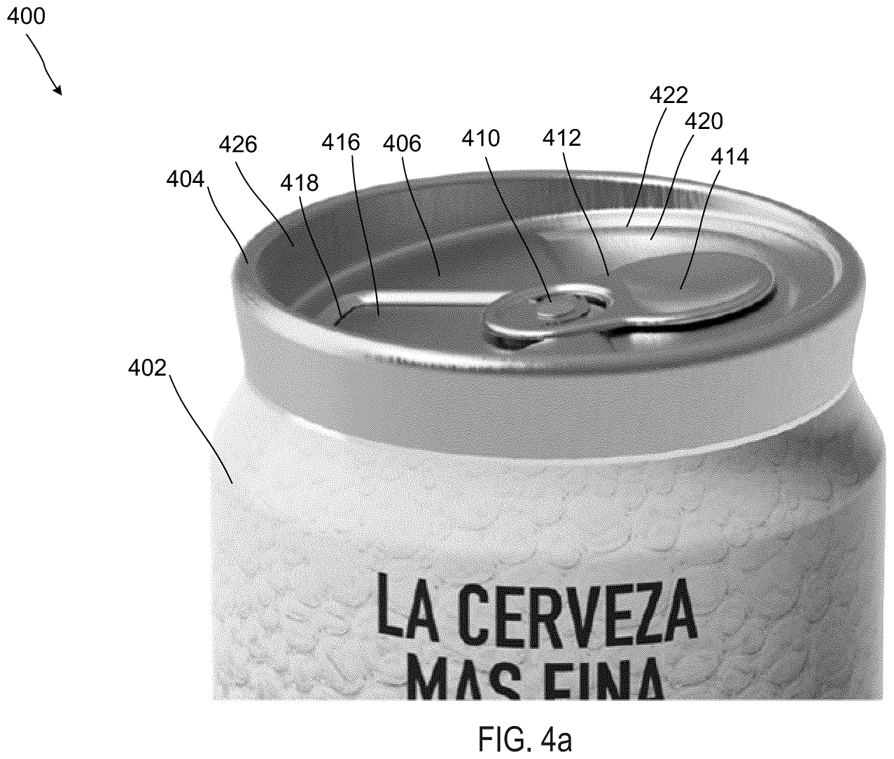

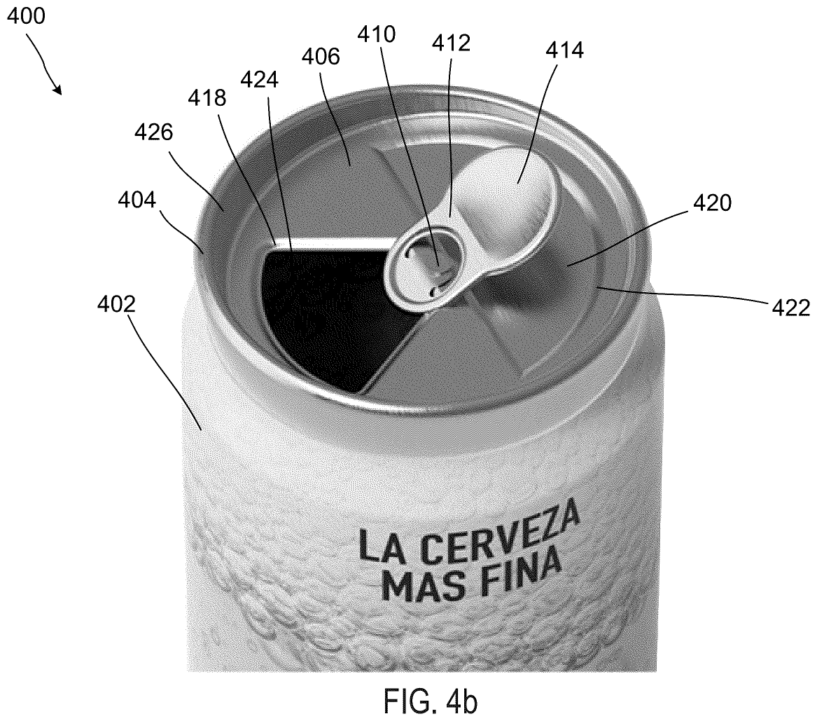

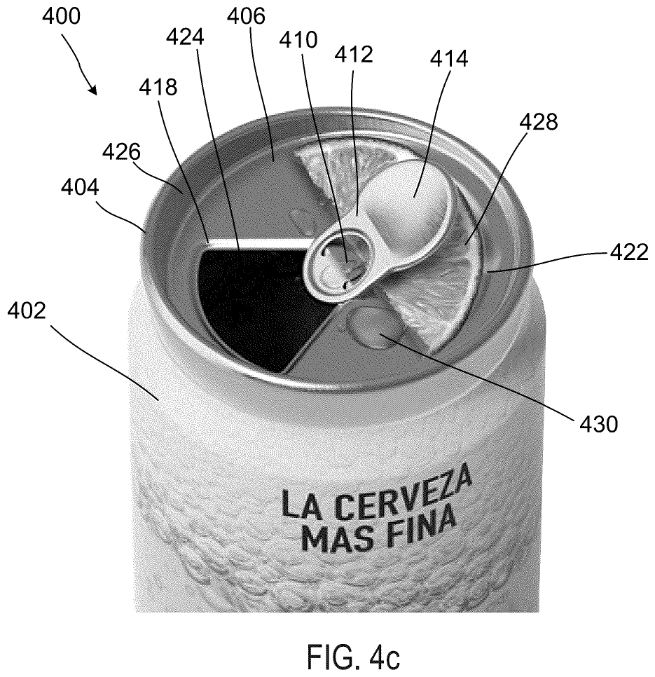

The lid 106 according to the disclosure also includes a locator depression 120. To add a juice to the contents of the container 100, with the squeeze tab lifted to the second position (as already described and as seen, for example in FIG. 4b), a fruit wedge may be placed in the locator depression 120 on the lid 106. The locator depression 120 may include a raised wall 122 on at least one side of the locator depression 120 to help direct the flow of juice. To make juice flow from the fruit wedge, a force may be applied to a tab depression 114 on an end of the squeeze tab 112 as it is in the second position, lifted above the fruit wedge located in the locator depression 120. As the force is applied to the tab depression 114 to move the squeeze tab 112 toward the first position, a convex bulge formed opposite the tab depression 114 squeezes the fruit wedge to release juice. The force on the fruit wedge from the convex bulge of the tab depression 114 expresses the juice from the fruit wedge in a gradual manner so that the release of juice is controlled and directed substantially outwardly across the top of the lid 106.

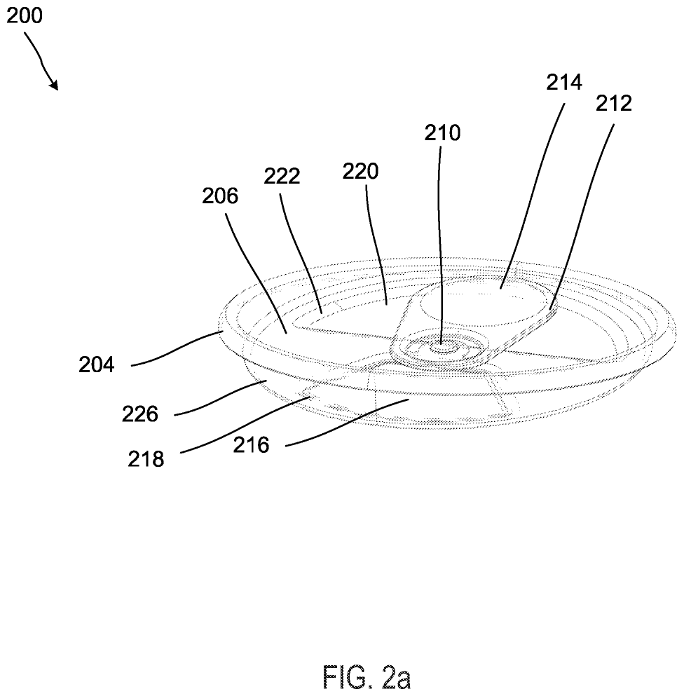

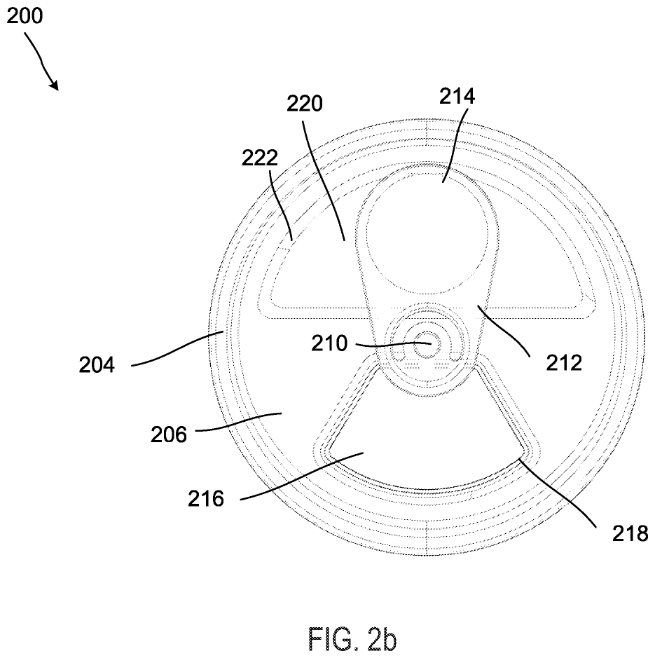

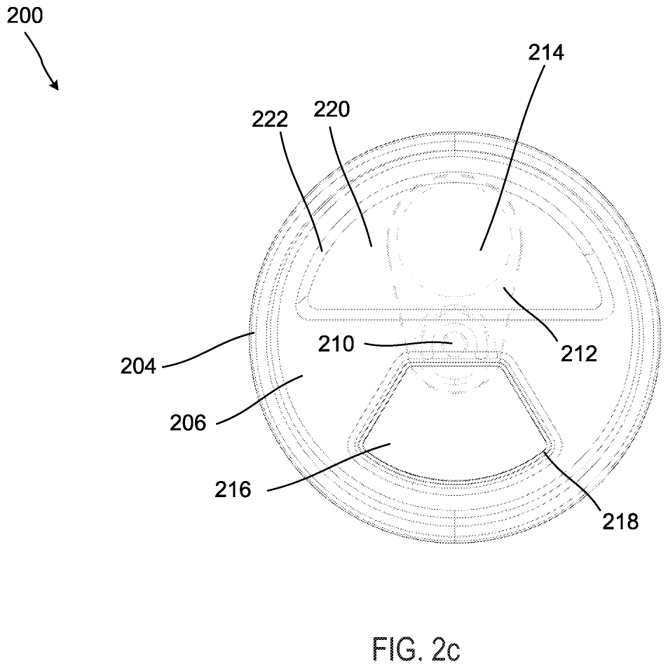

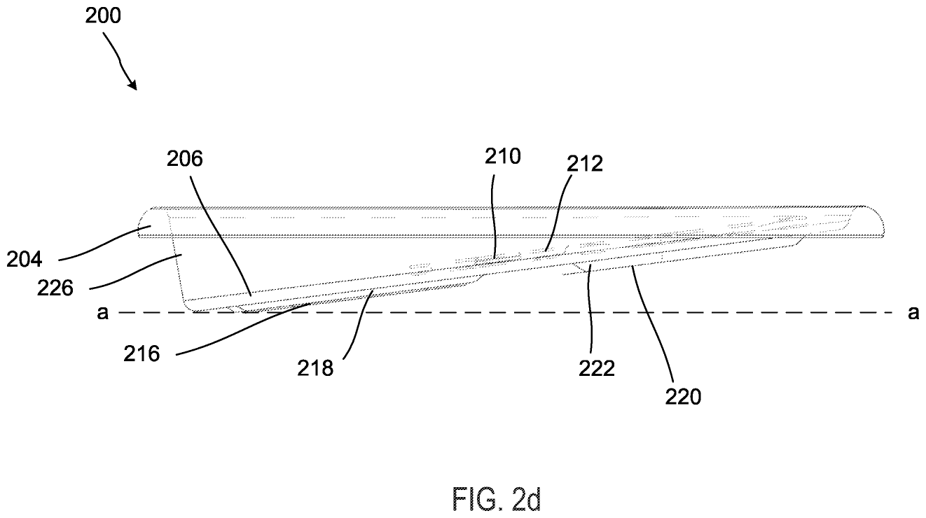

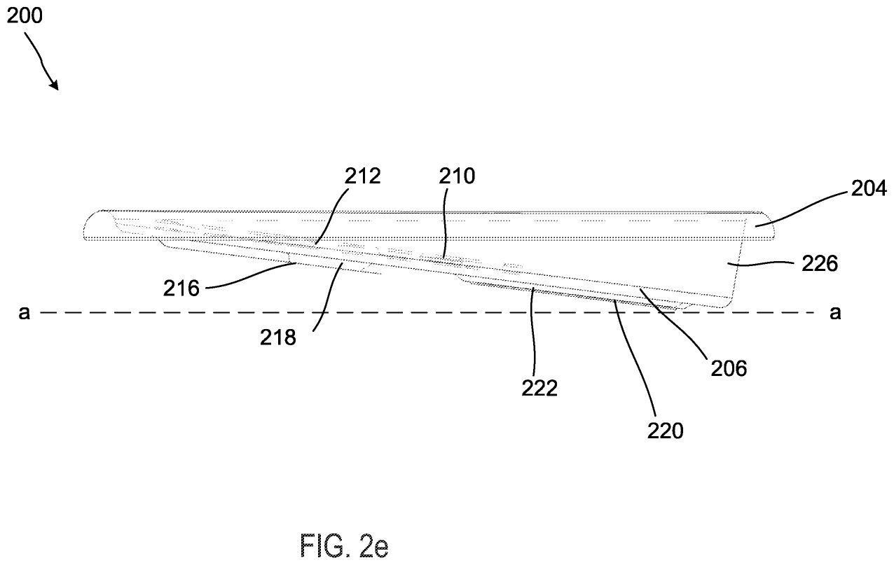

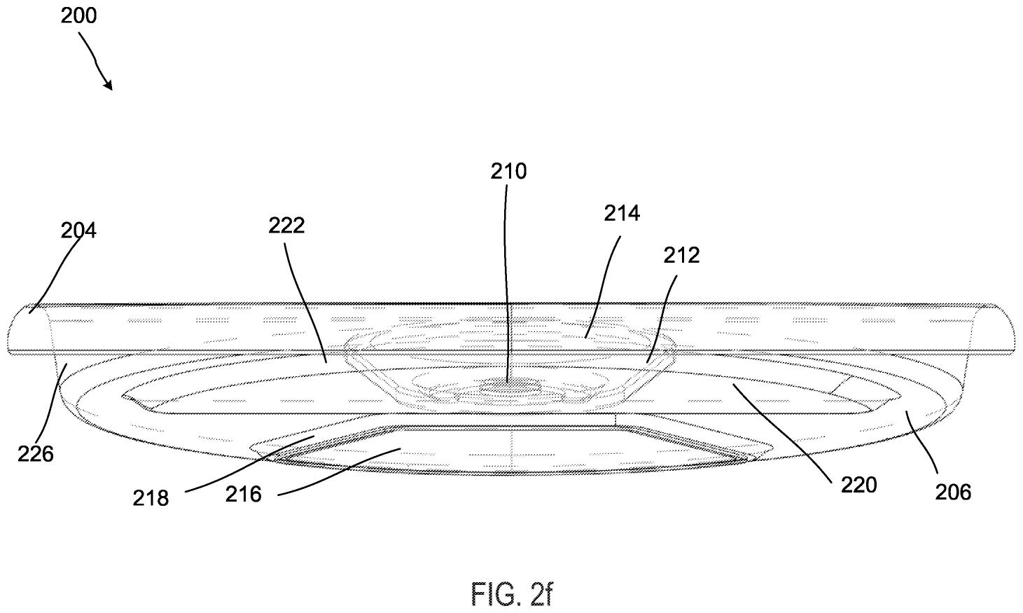

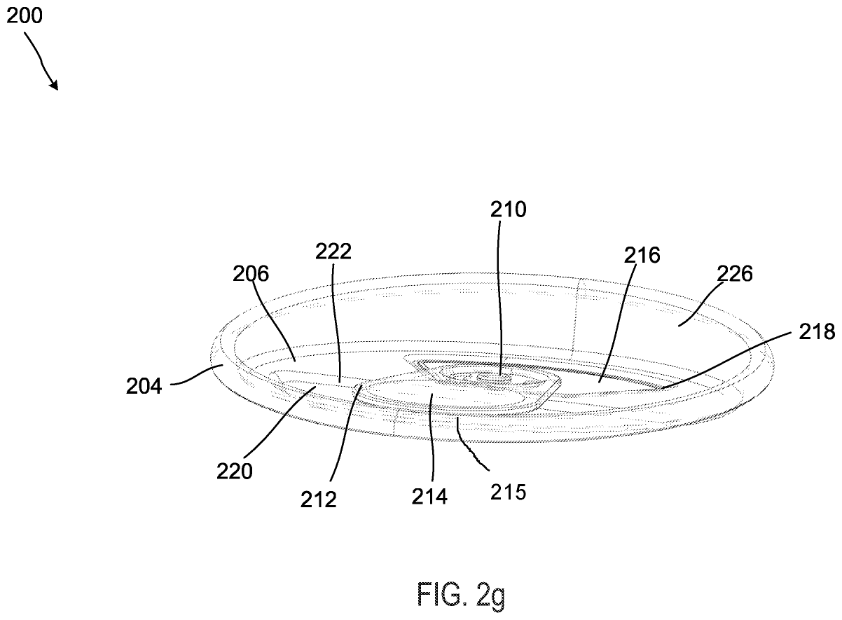

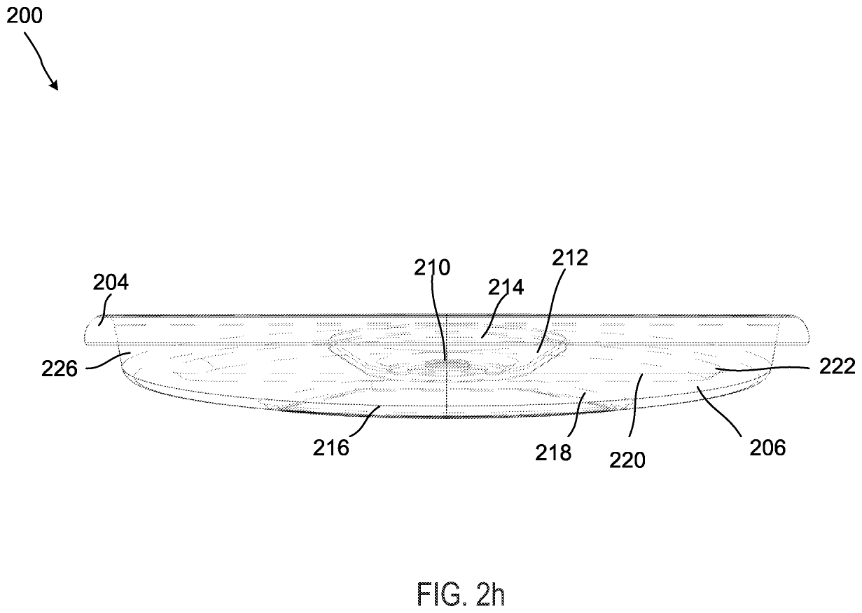

Referring to FIGS. 2a-2h, an embodiment of a squeeze lid 200 is illustrated in a sealed configuration. The lid 200 includes a rim 204 for engaging an edge of a body (e.g., 102 in FIG. 1) of a container. The lid 200 is disposed on the container to seal a beverage within the container. A surface 206 of the lid 200 includes features for performing a squeezing of an item, such as a fruit wedge (not shown) and adding a juice to the beverage within the container.

A rivet 210 is located substantially at a midpoint of the surface 206 of the lid 200 and connects a squeeze tab 212 to the lid 200. The squeeze tab 212 may include a tab depression 214 with a convex bulge 215 on the opposite side of the tab depression configured to receive a portion of a consumer's finger to apply a pressure to the squeeze tab positioned above a fruit wedge (shown e.g., in FIG. 4c) to extract a juice contained in the fruit wedge. A cover 216 for an opening or aperture in the lid 200 is located near a first end of the squeeze tab 212. The cover 216 seals the opening or aperture. A groove 218 defines the opening on the lid. The groove 218 is disposed along at least one edge of the cover 216. A locator depression 220 may be located near a second end of, and beneath, the squeeze tab 212 when the squeeze tab 212 is in a first, or down, position. The second end of the squeeze tab 214 may include the tab depression 214. The locator depression 220 in the lid is defined by at least one raised wall 222 and is shaped to receive and limit movement of the fruit wedge during the squeeze process described in detail hereinafter.

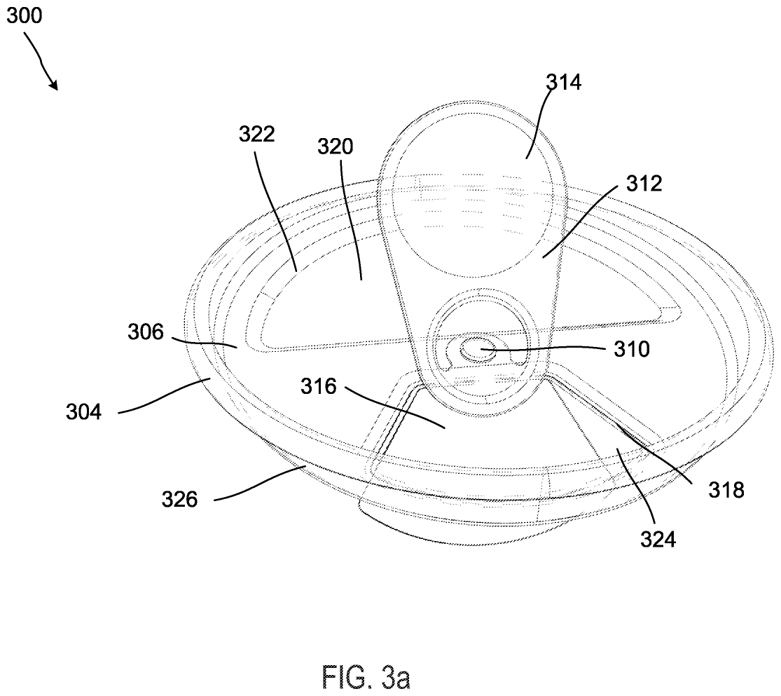

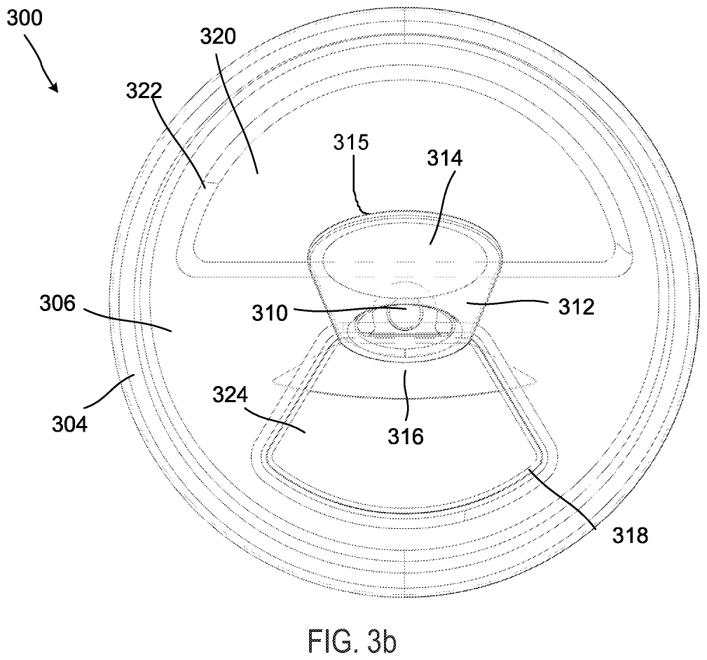

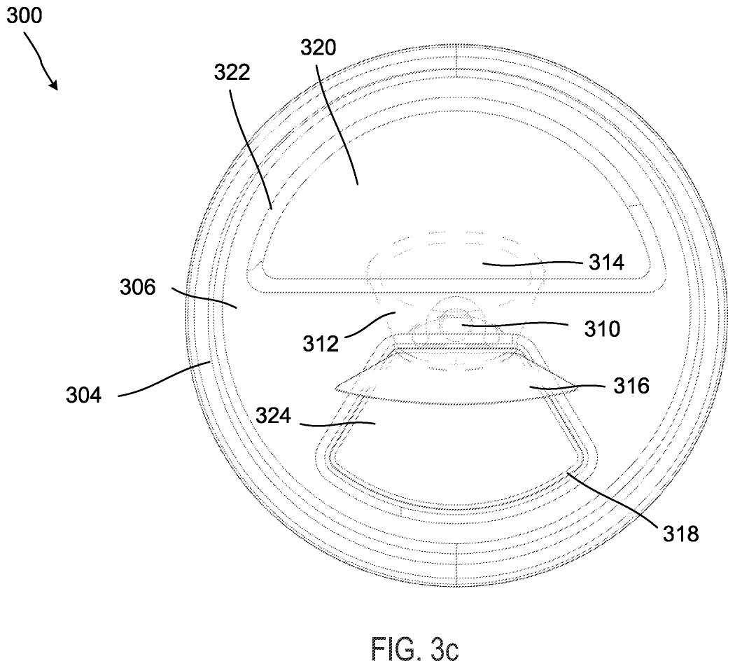

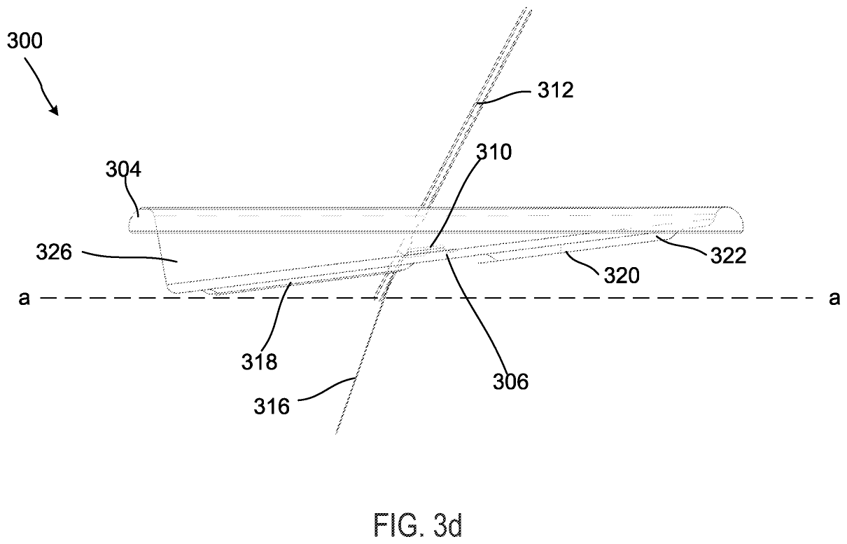

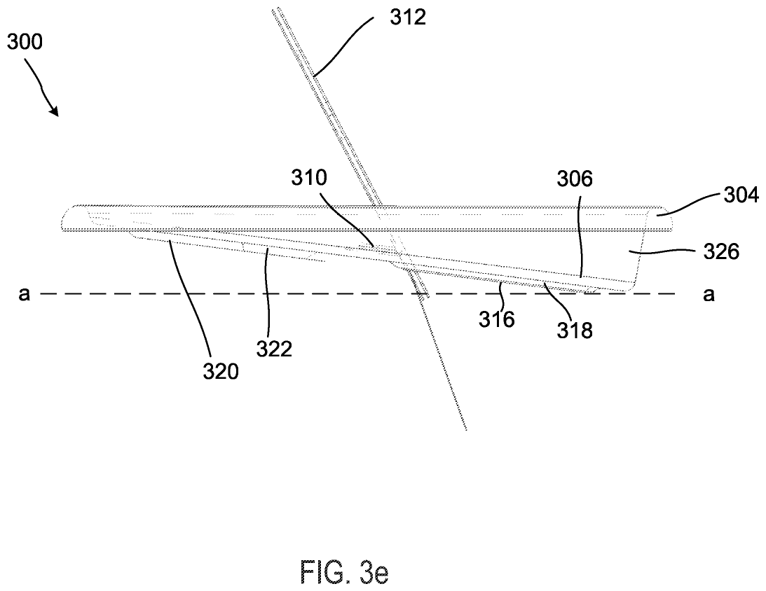

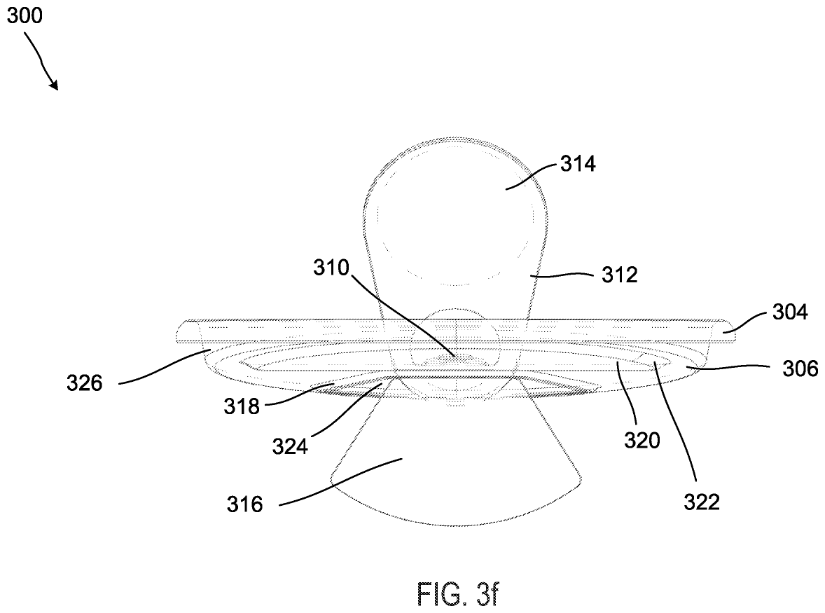

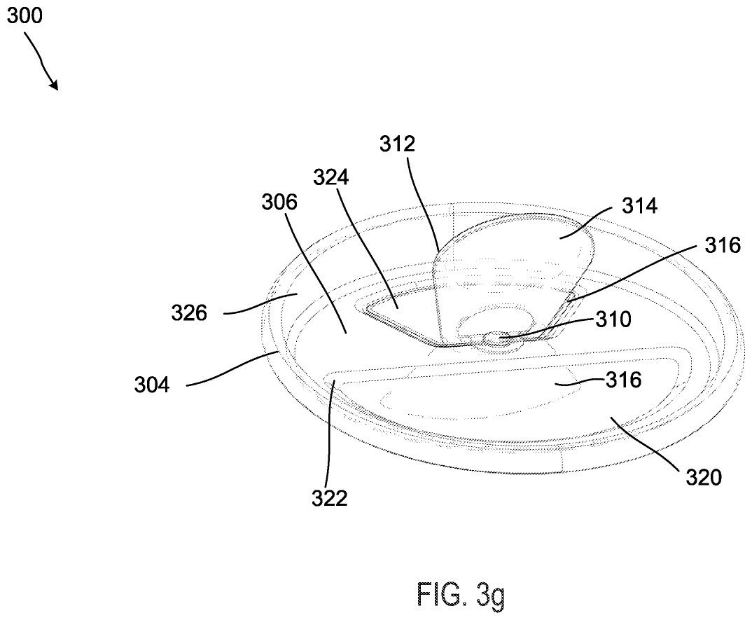

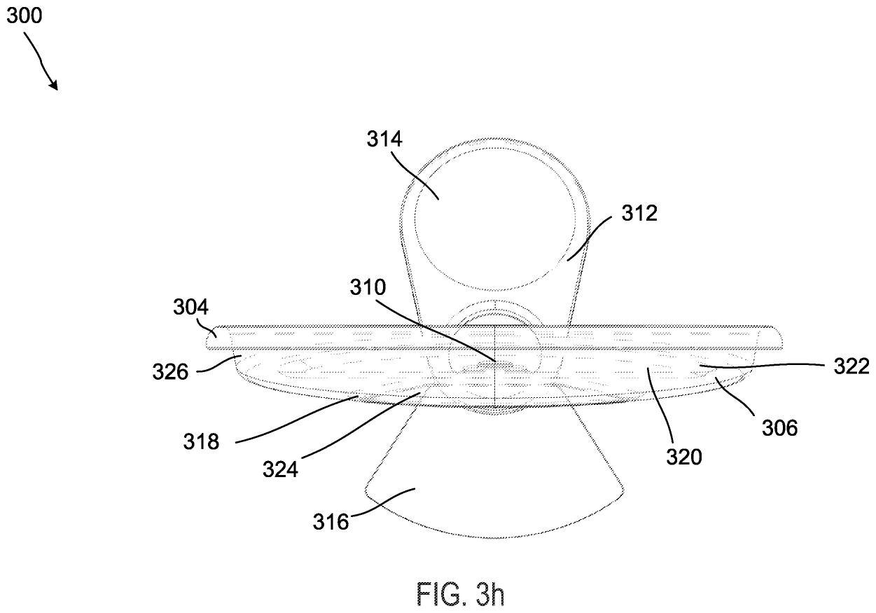

Referring still to FIGS. 2a-2h, opening the squeeze lid involves lifting the squeeze tab to the raised second position from the first position wherein it is proximate to the lid. As a result, the squeeze tab 210 may act as a lever with a fulcrum point about the rivet 210. The force of lifting the squeeze tab causes the cover 216 to disengage from the groove 218 and form an opening (see e.g., FIGS. 3a-3h). With the squeeze tab raised, a fruit wedge (shown in FIG. 4c) may be added at the location of the locator depression 220. The raised wall 222 of the locator depression 220 limits movement of the fruit wedge in the locator depression 210. Applying a force to the second end of the squeeze tab 212 when it is in the second position causes the squeeze tab 212 to actuate from the second position toward the a first position whereat the second end of the squeeze tab 212 is proximate to the locator depression 220. The force is applied to the squeeze tab 212 causing the squeeze tab 212 to actuate from the second position towards the first position causes the convex bulge 215 formed by the tab depression 214 to contact the fruit wedge and applies the force to the fruit wedge, thereby squeezing the fruit wedge and pressing juice from the fruit wedge.

In one embodiment, a lid 200 may be formed with the surface at an angle from a horizontal plane a-a (shown in FIGS. 2d-2e) to create a slope in the surface 206 of the lid 200. As an example, this slope may include an angle from 0 to 10 degrees from the horizontal plane a-a. A high point of the slope may be disposed proximate to the rim 204 near the locator depression 220. A low point of the slope may be disposed proximate to the rim 204 near the cover 216. As a result, the juice may flow down the slope from the locator depression 220 towards the low point of the slope/lid. Because the squeeze tab 212 may have been actuated from the first position towards the second position, the cover 216 is disengaged from the groove 218 forming the opening in the lid 216 for the juice to flow into and mix with the beverage. The juice may be guided towards the opening by a lid wall 226 of the lid 200 formed between the surface 206 and the rim 204. As the juice flows down the slope, it may contact the lid wall 226 surrounding the surface 206 of the lid 200. As a result, the juice is substantially contained on the surface 206 until it flows into the opening. An embodiment of the lid 200 with a 0 degree slope, or a lid 200 parallel to the horizontal plane a-a, may have the juice collect on the lid 200. The container may be moved, such as by being rotated, to direct the juice towards the opening. The juice may collect on the lid 200 until it reaches the opening and flows into the opening to mix with the beverage in a container. Accordingly, aspects of the squeeze lid described herein may be implemented with either a flat or sloped lid.

An embodiment of the lid 206 may include dimensions similar to 8 oz., 12 oz., or 16 oz. cans as understood by a person of ordinary skill in the art. For example, a lid 206 may have a diameter of approximately 2-2.5 inches. The lid 206 may have a height of approximately 0.25-0.5 inches and a rim 204 with a height of approximately 0.05-0.1 inches when measured from the surface of the lid 206.

A squeeze tab 212 of the container 200, according to the disclosure, may be approximately 1-1.5 inches long and approximately 0.5-1 inches wide at the widest portion of the tab depression 214. An embodiment of the squeeze tab 210 may have a width of approximately 0.768 inches. The tab depression 214 may have a diameter of approximately 0.5-0.75 inches. An embodiment of the tab depression 214 may have a diameter of approximately 0.64 inches. The locator depression 220 may have a length of approximately 1.5-2 inches and a radius of approximately 0.5-1 inches. An embodiment of the locator depression 220 may have a length of approximately 1.805 inches and a radius of approximately 0.84 inches. The length of the locator depression 220 may be measured along a straight edge of the tab depression 214.

The cover 216 may form a wedge shape having two equal sides forming a trapezoid with a width of approximately 1-1.5 inches at its widest. The cover may be approximately 0.5-1 inches long when measured from a side of the cover 216 proximate to the rivet 210 to a curved side of the cover 216 proximate to the rim 204. The curved side proximate to the rim 204 may form an angle of approximately 45-90 degrees when measured using the two equal sides of the cover 216. In other words, if the two equal sides were drawn to continue until they intersected, the resulting angle formed by the two sides would range from approximately 45 to approximately 90 degrees in various embodiments according to the disclosure. An embodiment of the cover 216 may form an angle of approximately 62 degrees when measured using the two equal sides. The widest portion of an embodiment of the cover 216 may be approximately 1.214 inches wide and have a length of approximately 0.816 inches.

An embodiment of the lid 206 may include a surface sloped at approximately seven (7) degrees. To achieve this embodiment, a first side of the surface of the lid 206 proximate to the depression 220 may be located approximately 0.073 inches below the top of the rim 204. A second side of the surface of the lid 206 proximate to the cover 216 may be approximately 0.324 inches below the top of the rim 204. Measured from a first side of the surface of the lid 206 to a second side of the surface of the lid 206 may result in an angle of elevation change of approximately 7 degrees.

In an embodiment of the lid 206, an angle may be formed between the horizontal plane a-a (shown in FIGS. 2d-2e) and the lid wall 226. The angle may be from approximately 90 to 150 degrees. An embodiment of the lid 206 may form an angle of approximately 100 degrees when measured from the horizontal plane to the lid wall 226 the rim 204.

Although example dimensions of the lid 206 are provided above, a person of ordinary skill in the art would understand these dimensions are provided solely to illustrate example embodiments of the lid. A person of ordinary skill in the art may deviate from the dimensions expressed above while remaining within the scope of the present disclosure. The dimensions given are approximate and intended to be illustrative of dimensions for 12 oz. aluminum cans as known in the art. A person of ordinary skill in the art may alter the dimensions described above to fit, for example, a 8 oz. container or a 16 oz. container, or any other beverage container as known in the art, without deviating from the scope of this disclosure.

FIGS. 3a-3h illustrate an embodiment of a squeeze lid 300 in an opened configuration, i.e., with a squeeze tab 312 lifted. A rim 304 of the lid 300 may be placed on an edge of a body of a container (e.g., 102 in FIG. 1) to seal the lid 300 against the container. A surface 306 of the lid 300 is formed with various features for performing a squeeze process, as described herein. A rivet 310 may be located about a midpoint of the surface 306 for connecting the squeeze tab 312 to the lid 300. The squeeze tab 312 is depicted in a second position, lifted, indicating the lid 300 is in the opened configuration. The squeeze tab 312 may include a tab depression 314 for applying a force to the squeeze tab 310 during the squeeze process. The tab depression 314 may form a convex bulge 315 on a side of the squeeze tab 312 opposite the tab depression 314.

A cover 316 may be disposed near a first end of the squeeze tab 310. The cover 316 is shown disengaged and separated from a groove 318. The groove 318 defines an opening 324. A locator depression 320 may be disposed on the surface 306 of the lid 300 proximate to the tab depression 314 when the squeeze tab 312 is in a first position (as shown in FIGS. 2a-2h). The locator depression 320 may be surrounded by a raised wall 322. The raised wall 322 may limit movement of a fruit wedge (e.g., such as illustrated in FIG. 4c) within the locator depression 320 during the squeeze process.

The surface 306 of the lid 300 may be at an angle compared to a horizontal plane a-a (shown in FIGS. 3d-3e). The surface 306 may have a high point (compared to the horizontal plane) proximate to the rim 304 near the locator depression 320 and a low point proximate to the rim 304 near the opening 324. A lid wall 326 may surround the surface 306 of the lid 300 connecting the surface 306 to the rim 304.

FIGS. 4a-4c illustrate a perspective view of a container 400 including an embodiment of a lid 406, such as described hereinbefore in the embodiments of FIGS. 1-3h. FIG. 4a illustrates an embodiment of the lid 406 with the cover 416 in a position sealing the opening (shown in FIG. 4b as element 424). A force may be applied to a squeeze tab 412 to actuate the squeeze tab 412 from a first position to a second position, moving the tab depression 414 away from a locator depression 420 on the lid 406. As the force is increased on the squeeze tab 412 it acts as a lever to open the cover 416 by separating it from a groove 418 along at least one edge of the cover 416. The squeeze tab 412 actuates about a rivet 410 connecting the squeeze tab 412 to the lid 406.

Once the cover 416 is in the open position, the squeeze tab 412 may be in the second position as illustrated in FIG. 4b. A fruit wedge 428 may be placed below the squeeze tab 412, i.e., between the bottom of the lifted squeeze tab 412 and on the top of the lid 406, and substantially in the locator depression 420, as illustrated in FIG. 4c. A raised wall 422 along an edge of the locator depression 420 may limit movement of the fruit wedge 428 within the locator depression 420. As a force is applied to the tab depression 414, a convex bulge as described herein on a side of the squeeze tab 412 opposite the tab depression 414 contacts the fruit wedge 428 and juice 430 may be pressed from the fruit wedge 428. The juice 430 may flow into the opening 424 and into a beverage within the container 400. A rim 404 and a lid wall 426 along an edge of the lid 406 may help contain the juice 430 on the top surface of the lid 406 as it flows into the opening 424.

Although fruits such as limes are discussed herein, a person of ordinary skill in the art should understand this disclosure includes embodiments involving other beverage garnishes. For example, in addition or in the alternative lime, lemon, grapefruit, orange, or vegetables such as onions or other fruits such as olives may be used with the squeeze lid according to the disclosure to add to the flavor profile of the beverage.

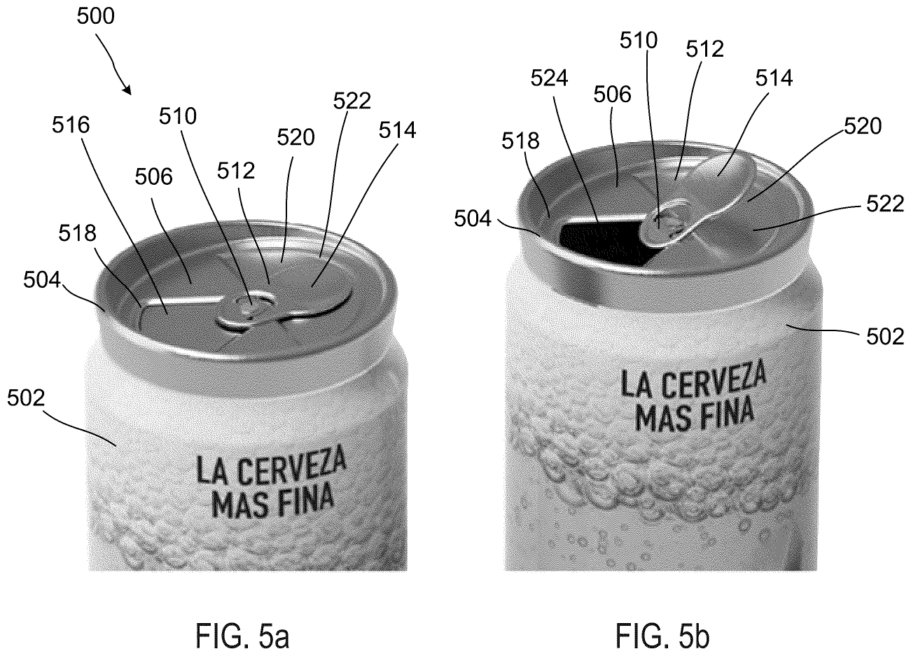

Referring to FIGS. 5a-5b, an embodiment of a container 500 with a squeeze lid 506 is illustrated. The lid 506 is illustrated in a sealed configuration in FIG. 5a. The lid 506 may include a rim 504 surrounding at least one edge of the lid 506. A rivet 510 may be located at an approximate midpoint of the lid 506. A squeeze tab 512 is connected to the lid 506 by the rivet 510. A tab depression 514 forming a convex bulge on a side of the squeeze tab 512 opposite the tab depression 514 may be formed on the squeeze tab 512 near an end thereof and located proximate to a locator depression 520 on a surface of the lid 506. A raised wall 522 may be located along at least one edge of the locator depression 520. A force applied to the squeeze tab 512 may actuate the squeeze tab 512 about the rivet 510 to rotate a cover 516 into an aperture/opening formed by the body 502. The cover 516 is sheared and separated from a groove 518 along at least one edge of the cover 516 by the force applied to the squeeze tab 512. An embodiment of the lid 506 with an open cover 516 is illustrated in FIG. 5b. The cover 516 in an open position forms an opening 524. The opening may be defined by the groove 518. In an embodiment, the opening 524 is formed in a trapezoidal or wedge shape. The trapezoid or wedge shape of the opening 524 may allow a fruit wedge (not shown) to be added to a beverage within the container 500.

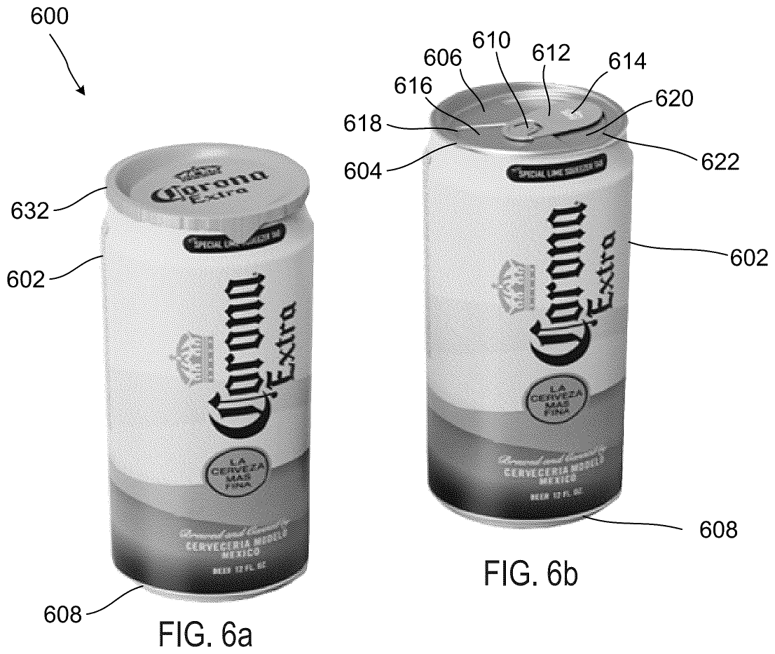

FIG. 6a illustrates a perspective view of a container 600 with an embodiment of a lid 606 and a cap 632. Referring to FIG. 6b, the lid 606 is exposed without the cap 632. The container 600 includes a body 602 having a first end and a second end. The lid 606 may be disposed at a first end of the body 602. A bottom 608 may be disposed at the second end of the body 602.

The lid 606 includes a rim 604 surrounding an edge of the lid 606. A rivet 610 located at an approximate midpoint of the lid 606 connects a squeeze tab 612 to the lid 606. A tab depression 614 may be located at an end of the squeeze tab 612 proximate to a locator depression 620 on a surface of the lid 606. A raised wall 622 may be located along at least one edge of the locator depression 620. A cover 616 may be located proximate to a side of the squeeze tab 612 distal to the locator depression 620. The cover 616 may be defined by at least one groove 618. The cover 616 may be shaped in the form of an enlarged wedge.

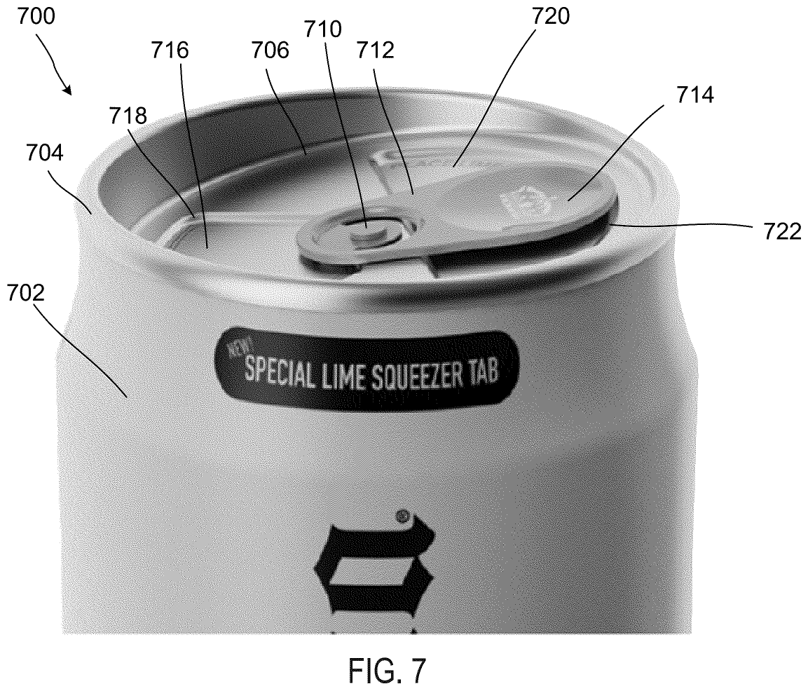

FIG. 7 illustrates a side perspective view of an embodiment of container 700 having a squeeze lid 706. The container 700 includes a body 702 having a first end and a second end. The lid 706 may be disposed at a first end of the body 702. The lid 706 includes a rim 704 surrounding an edge of the lid 706. A rivet 710 located at an approximate midpoint of the lid 706 connects a squeeze tab 712 to the lid 706. A tab depression 714 forming a convex bulge 315 on a side of the squeeze tab 712 opposite the tab depression 714 may be located at an end of the squeeze tab 712 proximate to a locator depression 720 on a surface of the lid 706. A raised wall 722 may be located along at least one edge of the locator depression 720. A cover 716 may be located proximate to a side of the rivet 710 distal to the locator depression 720. The cover 716 may be defined by at least one groove 718. The cover 716 may be shaped in the form of a wedge configured to receive a fruit wedge as described hereinbefore.

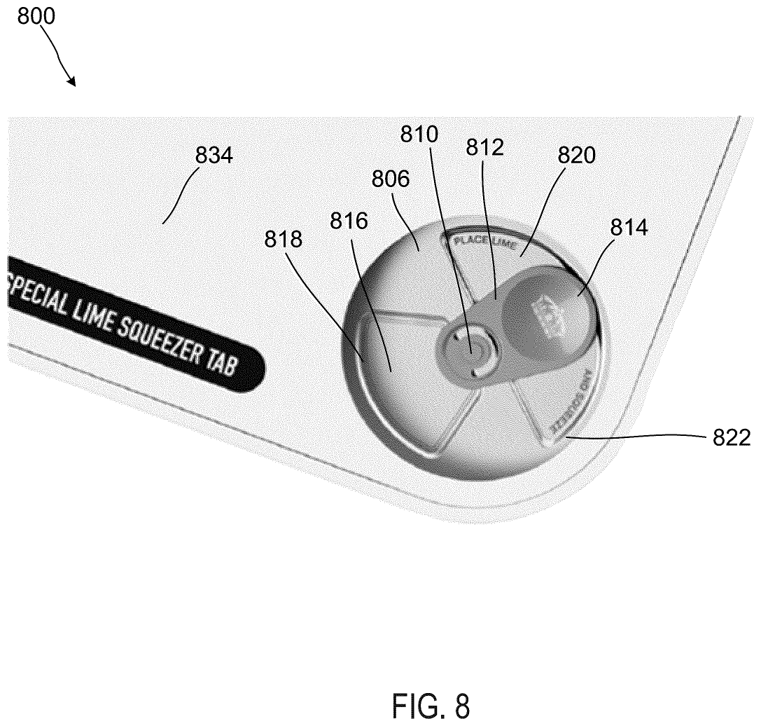

FIG. 8 illustrates a top view of a carrying package 834 storing a container 800 having a squeeze lid 806. The lid 806, as described in the embodiments of FIGS. 1-7, may include a rivet 810 connecting a squeeze tab 812 to the lid 806. The squeeze tab 812 may include a tab depression 814 proximate to a locator depression 820. A raised wall 822 may surround at least one edge of the locator depression 820. A cover 816 may be located proximate to the rivet 810 and defined by at least one groove 818 forming at least one edge of the cover 816. Although not illustrated in FIG. 8, the lid 806 in this embodiment may include a cap on the container 800 and within the carrying package 834, such as cap 632 illustrated and discussed hereinbefore with respect to FIG. 6a.

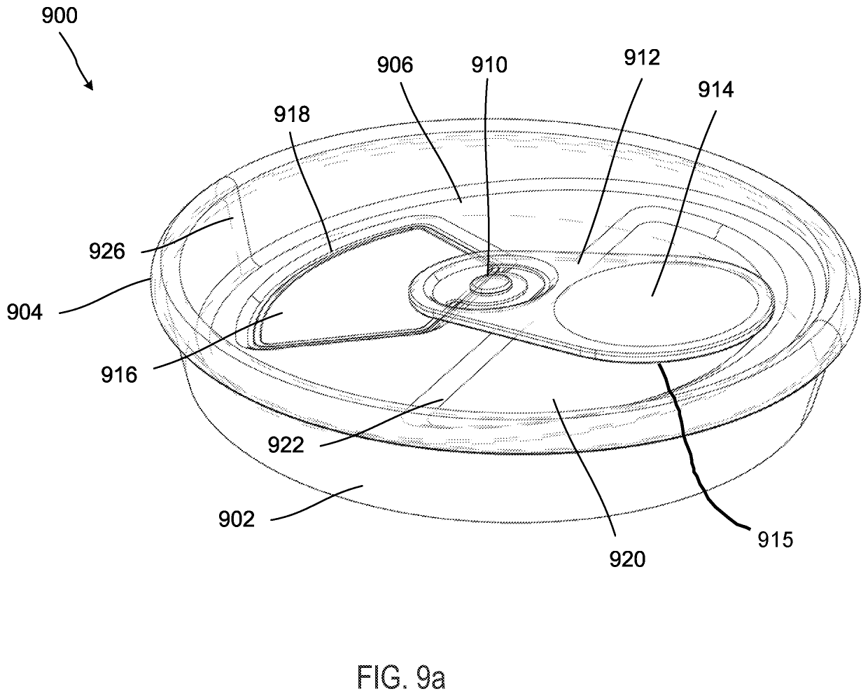

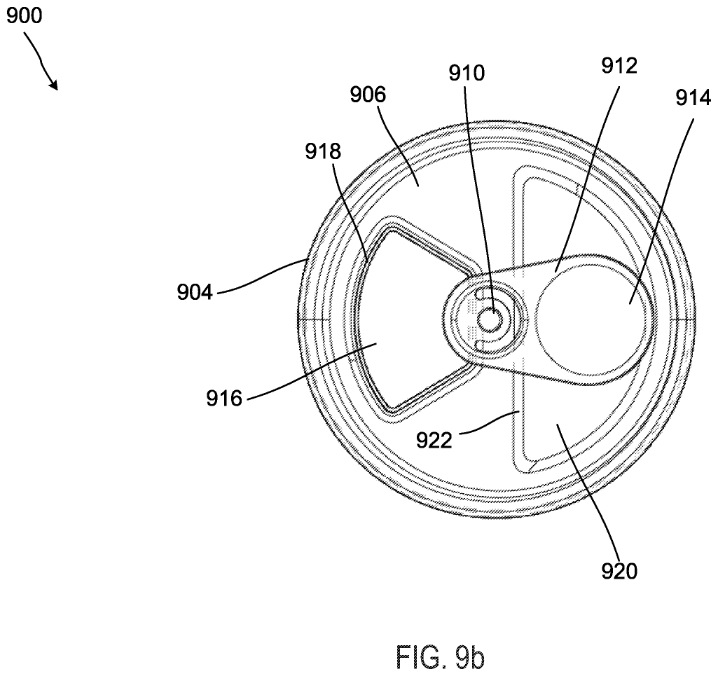

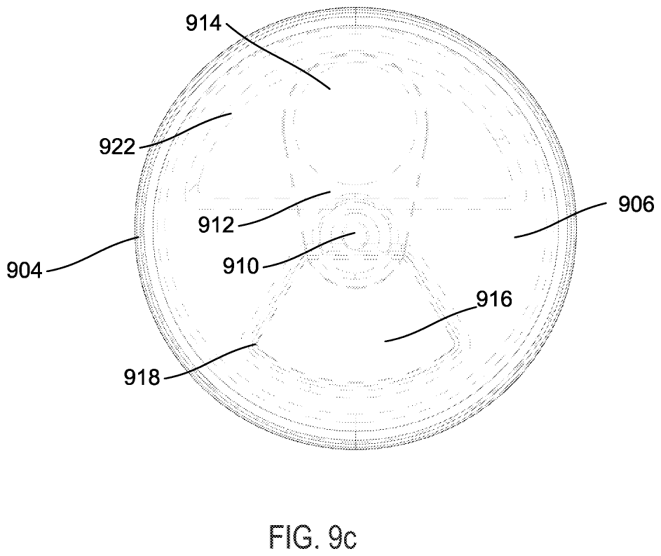

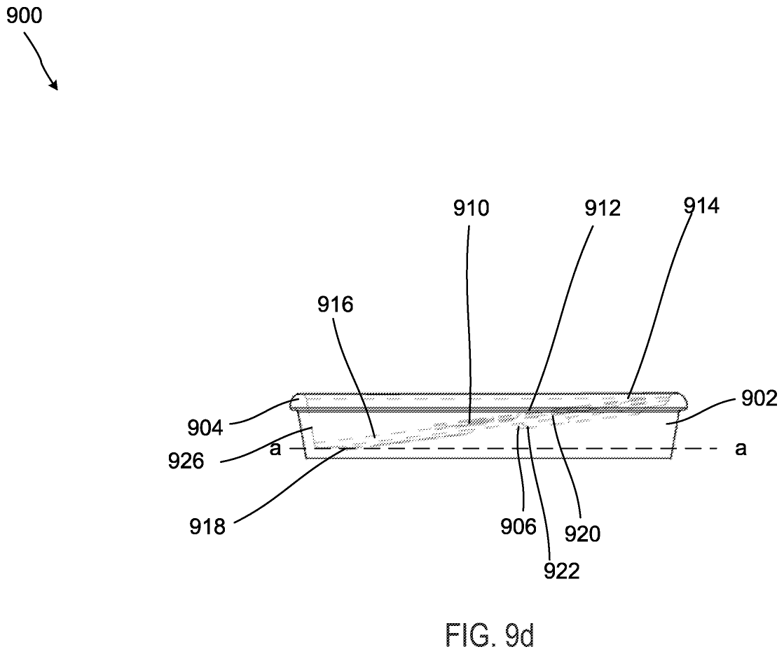

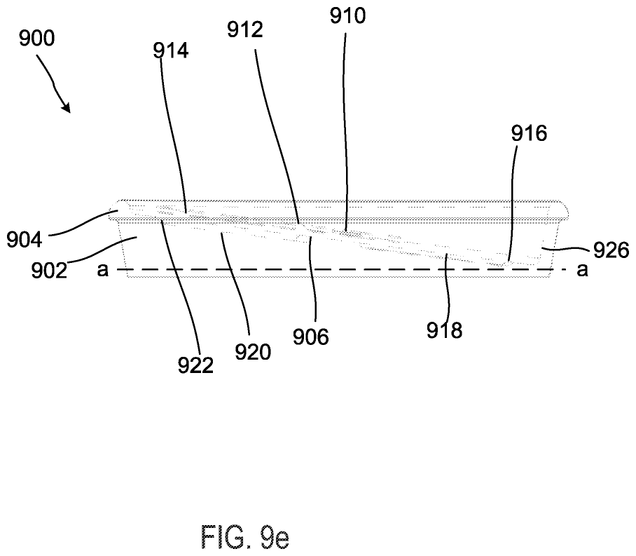

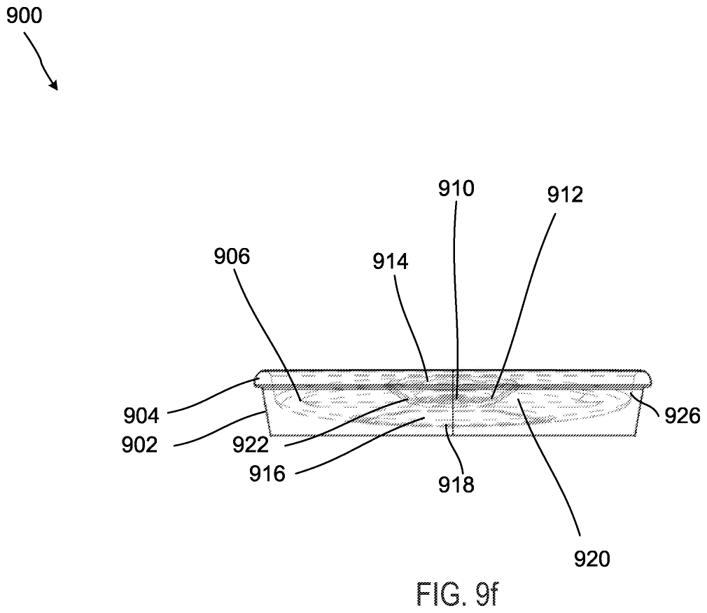

FIGS. 9a-9f illustrate a further embodiment of a container 900 with a squeeze lid 906 configured substantially as described hereinbefore. The lid 906 may have a descending portion 902 that may be connected within and to a body of the container (such as illustrated in FIG. 1). A rim 904 is formed along an edge of the lid 906 around the circumference of the lid 906. In an embodiment of the lid 906, the surface of the lid 906 may be flat, e.g., parallel to a horizontal plane (shown as line a-a in FIGS. 9d and 9e). Another embodiment of the lid 906 may include a surface of the lid 906 at an angle compared to the horizontal plane, as described herein.

As previously described, a rivet 910 may be located at an approximate midpoint of the lid 906 for connecting a squeeze tab 912 to the lid 906. The squeeze tab 912 may include a tab depression 914 forming a convex bulge 915 on a side of the squeeze tab 912 opposite the tab depression 914 for use in squeezing juice from a fruit wedge (e.g., as shown in FIG. 4c). The fruit wedge may be placed in a locator depression 920 formed with at least one raised wall 922 to limit movement of the fruit wedge in place during squeezing.

To perform squeezing, the squeeze tab 912 having a tab depression 914 is located on the lid 906 of the container 900. The squeeze tab 912 may be in a first position along the top of the lid 906. A force is applied to the squeeze tab 912 to actuate the squeeze tab 912 from the first position along the top of the lid 906 to a second, lifted, position and open a cover 916. In opening the cover 916, the cover 916 is sheared and displaced at a groove 918 around the perimeter of the cover 916, thereby unsealing the container 900. The cover 916 rotates into an aperture/opening formed in the lid 906, providing access to the body of the container 900. The cover 916 may rotate along an edge of the cover 916 where the cover 916 did not shear. The squeeze tab 912, having been moved to apply a force to the cover 916, may be in the second position, lifted, for placing the fruit wedge under the squeeze tab 912 before performing the squeeze. A fruit wedge may be placed in the locator depression 920 and a force, e.g., downward, may be applied to the tab depression 914.

The tab depression 914 may form a convex bulge 915 on a side of the squeeze tab 910 opposite the tab depression 914 and facing the fruit wedge. The force may be applied to the tab depression 914 to press the convex bulge against the fruit wedge and squeeze the fruit wedge so juice is expressed from the fruit wedge. In an embodiment of the lid 906, the lid 906 may be sloped at an angle compared to a horizontal plane a-a, the slope may contribute to guiding the juice into the opening (as previously described herein) and thereby into the container using gravity. In another embodiment of the lid 906, the lid 906 may be parallel to a horizontal plane a-a. As the juice is extracted from the fruit wedge, it may pool or run along a wall 926 of the lid until it reaches the opening. Alternatively, the container 900 may be moved, such as by rotating the container 900, to direct the juice into the opening.

An angle of the surface of the lid 906 may include an angle of approximately 0 degrees to approximately 10 degrees measured from the horizontal plane a-a, e.g., illustrated in FIGS. 9d and 9e. At 0 degrees, the surface of the lid 906 is flat and parallel to the horizontal plane. The embodiment of the lid 906 with a sloped surface may be angled up to approximately 10 degrees measured from the horizontal plane a-a to facilitate flow of the juice from the locator depression 920 to an opening in the cover 916. For example, a first and a second side view of the lid 906, shown in FIGS. 9d-9e illustrate a sloped lid 906. In an embodiment, the surface of the lid 906 may be closer to the peak of the rim 904 on a side of the lid 906 distal to the cover 916 and proximate to the locator depression 920. The surface of the lid 906 may be closer to the body of the container 900 on a side of the lid 906 proximate to the cover 916 and distal to the locator depression 920.

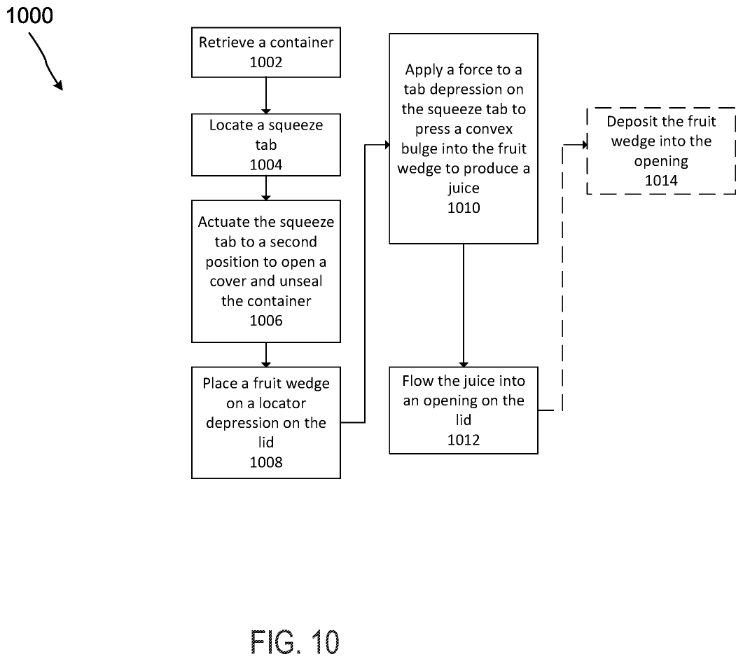

FIG. 10 illustrates a method of squeezing juice into a beverage including retrieving 1002 a container, having a squeeze lid as described in detail hereinbefore, filled with a beverage such as a carbonated beverage. The method involves locating 1004 a squeeze tab including a tab depression on a lid of the container, and actuating 1006 the squeeze tab lifting it from a first position to a second position to shear and displace a cover on the lid. The actuation of the squeeze tab thereby opens the cover, unsealing the container. A fruit wedge is placed 1008 in the lid below the lifted squeeze tab and for example (as described hereinbefore) on a locator depression on the lid of the container. A force may be applied 1010 to the tab depression of the squeeze tab, pressing a convex bulge located on the squeeze tab, wherein the convex bulge is opposite the tab depression, into the fruit wedge producing/pressing juice from the fruit wedge. The juice may flow 1012 into an opening on the lid. In an embodiment, the juice may be directed into the opening by flowing down a slope of the lid. Alternatively, if the lid does not have a slope, the juice may be directed across the top of the lid such as by moving the container, and into the opening to flavor the beverage. The fruit wedge, optionally, may be deposited 1014 into the opening, thereby adding the fruit wedge to the beverage within the container.

Although embodiments described herein are described as including, for example, a tab depression, or a locator depression, or a convex bulge or other features as described in the detailed embodiments, it should be appreciated by those skilled in the art that embodiments according to the disclosure and claims may include or not include any of the various features described.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

While various embodiments are disclosed herein, it should be understood that the invention is not so limited and modifications may be made without departing from the disclosure. The scope of the disclosure is defined by the appended claims, and all devices that come within the meaning of the claims, either literally or by equivalence, are intended to be embraced therein.

1. A container for a beverage comprising:
a body including a first end and a second end;
a lid disposed on the first end of the body;
a bottom disposed on the second end of the body;
a rivet at approximately a midpoint on a top surface of the lid;
a squeeze tab connected by the rivet to the lid, the squeeze tab including a tab depression on a first end of the squeeze tab distal from the rivet;
a locator depression in the lid and disposed on the top surface of the lid;
a raised wall on at least one side of the locator depression, the raised wall in part defining
a location for locating a fruit wedge therein.
a cover in the lid connected to a groove defining an edge of the cover; and
an opening in the lid sealed by the cover.

2. The container for a beverage of claim 1 further comprising a raised rim surrounding an edge of the lid, engaging the container.

3. The container for a beverage of claim 1 wherein the lid forms a sloped surface from a high point proximate to a rim near the locator depression to a low point proximate to the rim near the cover.

4. The container for a beverage of claim 1 wherein the lid forms a flat surface from a high point proximate to a rim near the locator depression to a low point proximate to the rim near the cover.

5. The container for a beverage of claim 1 wherein the squeeze tab is actuatable from a first position substantially parallel to the lid, to a second position wherein a portion of the squeeze tab engages the cover to open the opening in the lid.

6. The container for a beverage of claim 1 wherein the tab depression on the squeeze tab forms a convex bulge on a side of the squeeze tab opposite to the tab depression.

7. The container for a beverage of claim 1 wherein the locator depression is wedge-shaped for locating the fruit wedge therein.

8. A beverage container lid, comprising:
a rivet at approximately a midpoint on a top surface of the lid;
a squeeze tab connected by the rivet to the lid, the squeeze tab including a tab depression on a first end of the squeeze tab distal from the rivet;
a locator depression in the lid and disposed on the top surface of the lid;
a raised wall on at least one side of the locator depression, the raised wall in part defining a location for locating a beverage garnish to add a flavor profile to a beverage in the container using the squeeze tab.

9. The beverage container lid of claim 8 wherein the beverage container lid is attached to a beverage container comprising a body including a first end and a second end with the lid disposed on the first end of the body, and a bottom disposed on the second end of the body.

10. The beverage container lid of claim 8 wherein the location for locating a beverage garnish to add a flavor profile to a beverage in the container using the squeeze tab is configured to dispose a fruit wedge therein.

11. The beverage container lid of claim 8 further comprising a raised rim surrounding an edge of the lid.

12. The beverage container lid of claim 8 further comprising a cover in the lid connected to a groove defining an edge of the cover; and an opening in the lid sealed by the cover.

13. The beverage container lid of claim 12 wherein the lid forms a sloped surface from a high point proximate to a rim near the locator depression to a low point proximate to the rim near the cover.

14. The beverage container lid of claim 12 wherein the lid forms a flat surface from a high point proximate to a rim near the locator depression to a low point proximate to the rim near the cover.

15. The beverage container lid of claim 8 wherein the squeeze tab is actuatable from a first position substantially parallel to the lid, to a second position wherein a portion of the squeeze tab engages a cover to open an opening in the lid.

16. The beverage container lid of claim 8 wherein the tab depression on the squeeze tab forms a convex bulge on a side of the squeeze tab opposite to the tab depression.

17. The beverage container lid of claim 8 wherein the location for locating a beverage garnish to add a flavor profile to a beverage in the container using the squeeze tab is wedge-shaped.

18. A method of squeezing a juice into a beverage container, comprising:
retrieving a container containing a beverage;
locating a squeeze tab including a tab depression on a lid of the container;
actuating the squeeze tab from a first position to a second position to open a cover and unseal an opening in the container;
placing a fruit wedge on a locator depression on the lid of the container;
applying a force to the tab depression to actuate the squeeze tab from the second position towards the first position, to produce a juice to flow into the opening on the lid.

19. The method of squeezing a juice into a beverage container of claim 18 further comprising actuating the squeeze tab by engaging a tab depression to produce the juice to flow into the opening on the lid.

20. The method of squeezing a juice into a beverage container of claim 18 further comprising squeezing a convex bulge disposed opposite to the tab depression on the squeeze tab into the fruit wedge.
